(19) United States
(12) Patent Application Publication
(10) Pub. No.: US 2026/0088953 A1
(43) Pub. Date: Mar. 26, 2026

(54) FLEXIBLE MULTIPLE PORT SRS TRANSMISSION USING MULTIPLE SRS-RESOURCES

(71) Applicant: APPLE INC., Cupertino, CA (US)

(72) Inventors: Haitong Sun, Cupertino, CA (US); Hong He, San Jose, CA (US); Wei Zeng, San Diego, CA (US); Chunxuan Ye, San Diego, CA (US); Ankit Bhamri, Bad Nauheim (DE); Dawei Zhang, Saratoga, CA (US); Jie Cui, San Jose, CA (US)

(21) Appl. No.: 19/109,618

(22) PCT Filed: Sep. 29, 2022
(86) PCT No.: PCT/US2022/077226

§ 371 Date: Mar. 7, 2025

(51) Int. Cl. H04L 5/00

(52) U.S. Cl. CPC H04L 5/0048

(57) ABSTRACT

Embodiments herein provide sounding reference signals (SRS) enhancements to support flexible mapping of multiple SRS ports to multiple SRS resources. In some embodiments, a SRS-ResourceSet that includes multiple SRS-Resources configured as a set, wherein multiple SRS ports are distributed over more than one SRS-Resource of the set. A user equipment may transmit a SRS from each SRS port included in the multiple SRS-Resources of the set.

### TECHNICAL FIELD

This application relates generally to wireless communication systems, including mapping multiple sounding reference signal ports to multiple sounding reference signal resources or multiple symbols.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates SRS sequence mapping for an uplink transmission in accordance with some embodiments.

FIG. 2 illustrates a table that indicates a maximum number of cyclic shifts as a function of comb structure as designated by a NR standard.

FIG. 3 illustrates an SRS-ResourceSet for supporting multiple SRS ports distributed over more than one SRS-Resource in accordance with some embodiments.

FIG. 4 illustrates an SRS-ResourceSet for supporting multiple SRS ports and multiple panels distributed over more than one SRS-Resource in accordance with some embodiments.

FIG. 5 illustrates SRS-ResourceSet with a usage set equal to antenna switching in accordance with some embodiments.

FIG. 6 illustrates a method for a UE to perform SRS from SRS ports across multiple SRS-Resources in accordance with some embodiments.

FIG. 7 illustrates a method for a network node to configure SRS from SRS ports across multiple SRS-Resources in accordance with some embodiments.

FIG. 8 illustrates eight SRS ports divided into two groups of SRS ports to be transmitted on two different symbols in accordance with some embodiments.

FIG. 9 illustrates a TD-OCC codebook created from Hadamard matrix used to map multiple SRS ports to multiple symbols in accordance with some embodiments.

FIG. 10 illustrates a method for a UE to perform SRS from SRS ports across multiple symbols in accordance with some embodiments.

FIG. 11 illustrates a method for a network node to support SRS from SRS ports across multiple symbols in accordance with some embodiments.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Many wireless communication standards provide for the use of known signals (e.g., pilot or reference signals) for a variety of purposes, such as synchronization, measurements, equalization, control, etc. For example, in cellular wireless communications, sounding reference signals (SRS) may be used to estimate uplink channel quality. A wireless communication device or mobile device (i.e., UE) can transmit an SRS to a base station (e.g., eNB for LTE and gNB for NR). SRS gives information about the combined effect of multipath fading, scattering, Doppler and power loss of transmitted signal.

Using the SRS, the base station may estimate the channel quality and manage resources accordingly. For example, since the reference signals include data known to both the transmitter and the receiver, the receiver may use the reference signal to determine/identify various characteristics of the communication channel. This is commonly referred to as channel estimation, which is used in many high-end wireless communications such as LTE and 5G-NR communications. Known channel properties of a communication link in wireless communications are referred to as channel state information (CSI), which provides information indicative of the combined effects of, for example, scattering, fading, and power decay with distance. The CSI makes it possible to adapt transmissions to current channel conditions, which is useful for achieving reliable communications with high data rates in multi-antenna systems.

Oftentimes multi-antenna systems use precoding for improved communications. Precoding is an extension of beamforming to support multi-stream (or multi-layer) transmissions for multi-antenna wireless communications and is used to control the differences in signal properties between the respective signals transmitted from multiple antennas by modifying the signal transmitted from each antenna according to a precoding matrix. In one sense, precoding may be considered a process of cross coupling the signals before transmission (in closed loop operation) to equalize the demodulated performance of the layers. The precoding matrix is generally selected from a codebook that defines multiple precoding matrix candidates, wherein a precoding matrix candidate is typically selected according to a desired performance level based on any of a number of different factors such as current system configuration, communication environment, and/or feedback information from the receiver receiving the transmitted signal(s).

The feedback information may be used in selecting a precoding matrix candidate by defining the same codebook at both the transmitter and the receiver, and using the feedback information from the receiver as an indication of a preferred precoding matrix. Similarly, the feedback information may be used in selecting preferred ports for UE transmission.

An SRS design may include symbol location, repetition, comb, and cyclic shift. In NR Release-15 (Rel-15), a design for the SRS was outlined. In Rel-15, SRS can only be transmitted in the last 6 symbols of each slot. Further, the SRS can be repeated up to four symbols, and the SRS supports Comb 2/4.

NR Release-16 (Rel-16) provided enhancements for the SRS of Rel-15. In Rel-16, the SRS could be transmitted in any symbol in a slot. Further SRS supported repetition with 8 and 12 symbols.

NR Release-17 (Rel-17) provided further enhancements for SRS. For example, Rel-17 supported RB-level Partial Frequency Sounding (RPFS). For RPFS, Rel-17 supports start PRB location hopping. Rel-17 also supports SRS repetition with 10/14 symbols. Further, Rel-17 supported Comb 8. For Comb 8, Rel-17 supported a maximum of 6 cyclic shifts (CS).

In current NR, SRS has four different usage, configured in usage in SRS-ResourceSet. One usage for SRS is codebook based uplink. For Codebook based uplink, the SRS resource set usage may be set equal to “codebook.” The UE transmits SRS resource with multiple ports, and the network schedules PUSCH by indicating the transmit precoding matrix (TPMI) and the rank indication (RI). A second usage for SRS in non-codebook based uplink. For non-Codebook based uplink the SRS resource set usage may be set equal to “nonCodebook.” The UE transmits multiple SRS resources, each with a single port. The network schedules PUSCH by indicating the SRS resource and port selection and RI (rank indication). A third usage for SRS is antenna switching. For antenna switching, the SRS resource set usage may be set equal to “antennaSwitching.” A fourth usage for SRS is beam management. For beam management, the SRS resource set usage may be set equal to “beamManagement.”

For multiple port SRS transmission, current NR only supports all ports in one SRS symbol. A single SRS-Resource can support multiple symbols by adopting simple repetition. In other words, the single SRS-Resource can be repeated across multiple symbols. Additionally, currently NR only supports a maximum of four ports for SRS. Each SRS port is characterized by a comb offset and cyclic shift.

In certain communication systems, it may be desirable to provide SRS enhancements to support a more flexible multi-port SRS transmission. For example, it may be desirable to support eight ports. A system with flexible multi-port SRS transmission may support additional ports (e.g., eight ports) using various embodiments described herein. In some embodiments, flexible mapping may be used to map multiple SRS ports to multiple SRS resources. In some embodiments, flexible mapping may be used to map multiple SRS ports to multiple symbols.

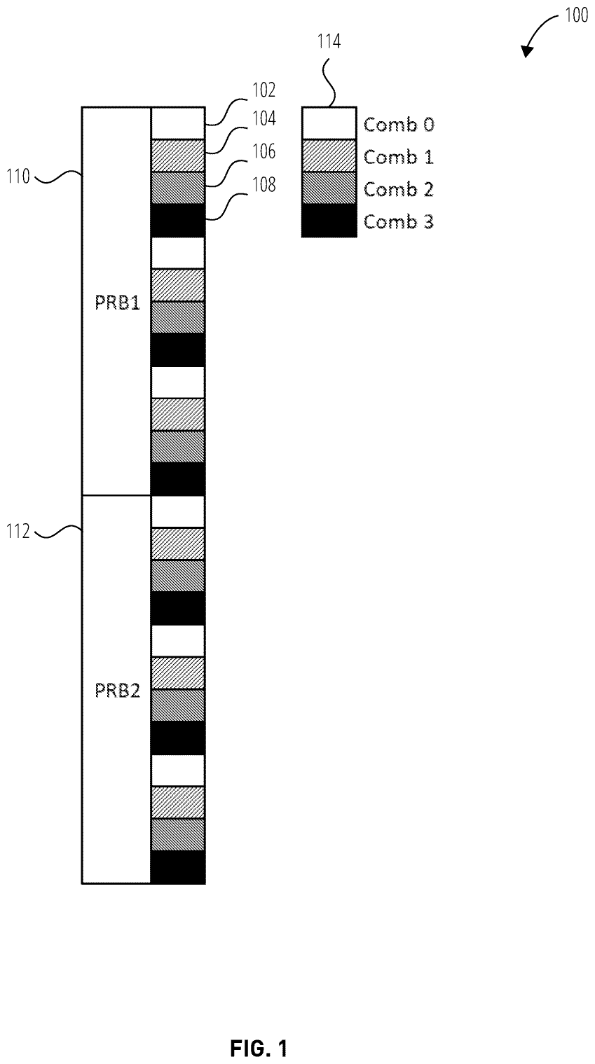

FIG. 1 illustrates SRS sequence mapping for a transmission 100. As shown, the transmission 100 includes a number of resource elements (REs) (e.g., first RE 102, second RE 104, third RE 106, and fourth RE 108). A RE is a frequency-time unit to which an SRS sequence is mapped. The transmission 100 further comprises multiple physical resource blocks (PRBs) (e.g., PRB1 110 and PRB2 112) comprising a plurality of contiguous REs. The SRS sequence may support a length of 6, 12, 18, 24, and any sequence greater than or equal to 36.

To support multiple ports and UEs, a comb structure for the transmission 100 may be used. An SRS sequence may be mapped to the frequency domain resources (e.g., first RE 102, second RE 104, third RE 106, and fourth RE 108) with the comb structure. NR currently supports comb 2, 4, and 8 for SRS. A comb 2 structure would be a case where an SRS is transmitted every other RE. FIG. 1 illustrates a comb 4 structure. As shown, in a comb 4 structure, the SRS sequences are transmitted every four resource elements. This provides four possible comb offsets 114. The comb offsets indicate the starting frequency of the comb structure for an SRS sequence. Similarly, an 8 comb structure would cause an SRS to transmit every eighth resource element. Transmitting according to a comb structure allows ports from the same UE or different UEs to transmit an SRS sequence without interfering with other SRS sequences. Comb N (N=2/4/8) subsamples the RE with a factor N, different comb offsets are orthogonal since they are non-overlapping in frequency Another way for SRS transmissions to not interfere with other SRS transmissions is to apply multiple cyclic shift sequence on top of a same SRS sequence. The cyclic shift allows multiple transmission to be applied on the same frequency RE by overlapping orthogonal sequences. Thus, a wireless communication system may use comb structure and cyclic shift to increase its capacity. A length M cyclic shift sequence can have M orthogonal sequences. Thus, a length M cyclic shift can be used to create M orthogonal SRS sequence using the same SRS comb offset. The cyclic shift sequence length M may be a function of Comb size N.

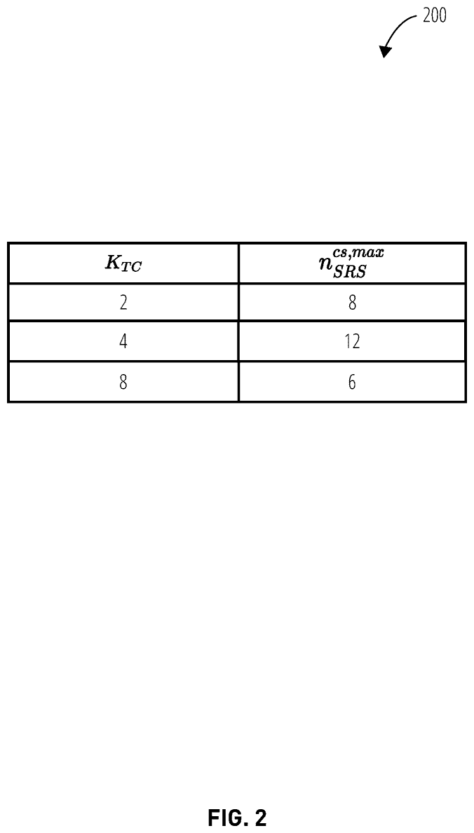

FIG. 2 illustrates a table 200 that indicates a maximum number of cyclic shifts (n_{SRS}^{cs,max}) as a function of comb structure (K_{TC}) as designated by a NR standard. For each comb structure there is a defined number of cyclic shifts in the NR standards. This determines how many SRS patterns can be used. For example, there may eight cyclic shifts for a comb 2 structure resulting in 16 (i.e., 2*8=16) ports or UEs that can be supported. As shown, in some embodiments, a Comb 2 has maximum 8 cyclic shifts, a Comb 4 has maximum 12 cyclic shifts, and a Comb 8 has maximum 6 cyclic shifts.

Embodiments herein propose using multiple resources or multiple symbols to support additional ports using flexible mapping to further enhance SRS. Currently, some releases of NR only support four port SRS-Resources. In some embodiments, a SRS-ResourceSet may include multiple SRS-Resources. Previously, for codebook usage, the different SRS-Resources would be used to support multiple panels with each panel limited to supporting 4 ports SRS-Resource. Embodiments herein describe how multiple SRS ports can be supported over more than one SRS-Resource.

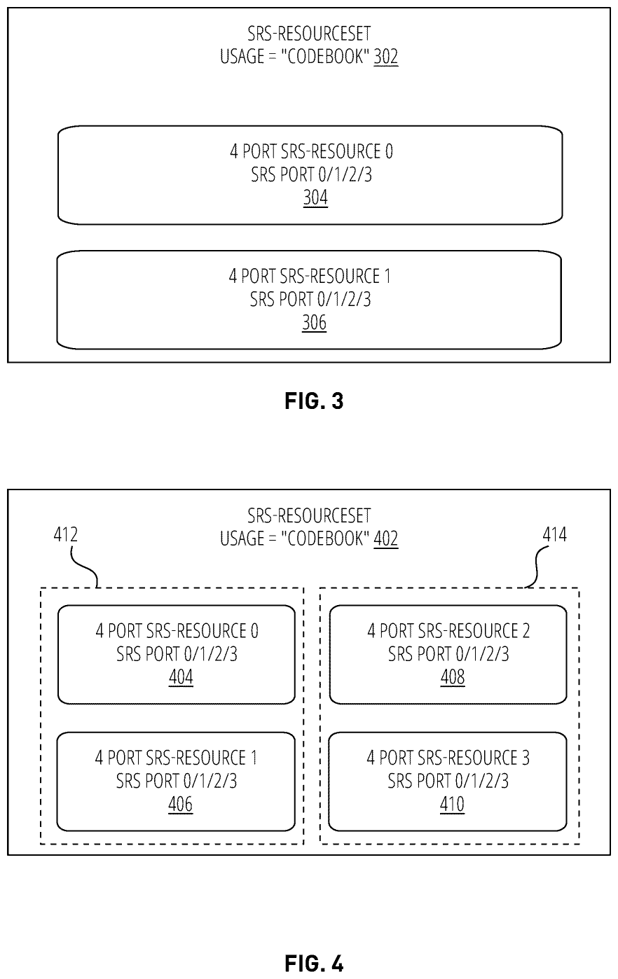

For example, FIG. 3 and FIG. 4 illustrate embodiments where, for codebook based uplink operation (e.g., SRS ResourceSet usage=“codebook”), multiple SRS ports can be distributed over more than one SRS-Resource. The distributing multiple SRS ports over more than one SRS-Resource may be used to support SRS for more than four ports of a panel. Wireless communication systems can support one or both of the embodiments shown in FIG. 1 and FIG. 2.

FIG. 3 illustrates an SRS-ResourceSet 302 for supporting multiple SRS ports distributed over more than one SRS-Resource. For example, for eight ports codebook based uplink operation, one set of SRS-Resources configured in the SRS-ResourceSet 302 can be used to support multiple SRS ports. The set of SRS resources, in the illustrated embodiment, comprises two SRS-Resources (e.g. SRS-Resource 0 304 and SRS-Resource 1 306). Each SRS-Resource of the set may comprise four ports. In order to support eight ports, the SRS-Resource 0 304 may be configured to support a first four ports, and the SRS-Resource 1 306 may be configured to support a second four ports. Both the SRS-Resource 0 304 and the SRS-Resource 1 306 may be linked together to configure a pair of SRS-Resources configured to support eight ports.

FIG. 4 illustrates an SRS-ResourceSet 402 for supporting multiple SRS ports and multiple panels distributed over more than one SRS-Resource. As shown, two sets of SRS-Resources (e.g., first set of SRS-Resources 412 and second set of SRS-Resources 414) can be configured in the same SRS-ResourceSet 402. The sets of SRS-Resources may be referred to as groups or pairs of SRS-Resources.

Each set can be used to support multiple SRS ports distributed across the SRS-Resources. For instance, the first set of SRS-Resources 412 may comprise SRS-Resource 0 404 and SRS-Resource 1 406. SRS-Resource 0 404 may be configured to support a first set of ports of a first panel, and the SRS-Resource 1 406 may be configured to support a second set of ports of a first panel. The second set of SRS-Resources 414 may comprise SRS-Resource 2 408 and SRS-Resource 3 410. SRS-Resource 2 408 may be configured to support a first set of ports of a second panel, and the SRS-Resource 3 410 may be configured to support a second set of ports of a second panel.

For example, for eight ports codebook based uplink operation, four SRS-Resources can be configured in SRS-ResourceSet 402. Each SRS-Resource may have 4 ports. The SRS-Resources configured in the SRS-ResourceSet 402 may be grouped into sets (e.g., first set of SRS-Resources 412 and second set of SRS-Resources 414). Each set of SRS-Resources may contain two SRS-Resources to support eight port uplink operation in each set of SRS-Resources.

While the illustrated embodiment only shows two pairs of SRS-Resources (e.g., first set of SRS-Resources 412 and second set of SRS-Resources 414), other embodiments may include a SRS-ResourceSet with more pairs of SRS-Resources to support additional panels. The specific grouping of the resources may be defined by a 3GPP specification. The grouping may link SRS-Resources together as a way to associate the ports to allow the group of SRS-Resources to support more ports than a single SRS-Resource could by itself. For example, two different four port SRS-Resources may be combined to create a group of SRS-Resources capable of supporting eight ports. Additionally, in some embodiments, the groupings of SRS-Resources may include more than two SRS-Resources to support more than eight ports.

For codebook based uplink operation (e.g., SRS ResourceSet usage=“codebook”), when multiple SRS ports are distributed over a set of more than one SRS-Resource (as described with reference to FIG. 3 and FIG. 4), the network node may configure the “Precoding information and number of layers” field in downlink control information (DCI) according to a known order. For example, in terms of the interpretation of “Precoding information and number of layers” field in DCI, the UE may anticipate the order of SRS ports mapped to TPMI (Transmit Precoder Matrix Indicator) in a particular order. The TPMI may be used to indicate the precoder to be applied over the layers.

In some embodiments, for TPMI to SRS port mapping, the SRS ports of multiple SRS-Resources in the same set (e.g., pair) may be concatenated based on the order of SRS-Resource in the SRS-ResourceSet configuration. For example, in FIG. 3 assuming SRS-Resource 0 304 is configured before SRS-Resource 1 306 in SRS-ResourceSet 302, the order of the SRS ports to map to TPMI may be: {SRS-Resource 0 port 0, SRS-Resource 0 port 1, SRS-Resource 0 port 2, SRS-Resource 0 port 3, SRS-Resource 1 port 0, SRS-Resource 1 port 1, SRS-Resource 1 port 2, SRS-Resource 1 port 3}.

In some embodiments, for TPMI to SRS port mapping, the SRS ports of multiple SRS-Resources in the same set (e.g., pair) may be ordered in an alternating pattern. Using FIG. 3 as an example, the order of the SRS ports to map to TPMI may be: {SRS-Resource 0 port 0, SRS-Resource 1 port 0, SRS-Resource 0 port 1, SRS-Resource 1 port 1, SRS-Resource 0 port 2, SRS-Resource 1 port 2, SRS-Resource 0 port 3, SRS-Resource 1 port 3}.

For codebook based uplink operation (e.g., SRS-ResourceSet usage=“codebook”), when multiple SRS ports are distributed over a set of more than one SRS-Resource, and two sets are configured in the SRS-ResourceSet as shown in FIG. 4, the network node may configure the SRS resource indicator (SRI) field in DCI to indicate the two sets.

For example, the SRS-Resources may be grouped into two sets based on the order of the SRS-Resources in the SRS-ResourceSet configuration. Each set may contain equal or almost equal number of SRS-Resource. The UE may interpret the SRI field in DCI to indicate one of the two sets (e.g., pairs) of SRS-Resources. For example, in some embodiments the first set maps to SRI=0, and the second set maps to SRI=1. In the example shown in FIG. 4, assuming the SRS-Resource order in SRS-ResourceSet configuration is {SRS-Resource 0 404, SRS-Resource 1 406, SRS-Resource 2 408, SRS-Resource 3 410}, the first set comprises {SRS-Resource 0 404, SRS-Resource 1 406} and maps to SRI=0, and the second set comprises {SRS-Resource 2 408, SRS-Resource 3 410} and maps to SRI=1. In other words, the SRI may be used by the network node to indicate a set or pairing of SRS resources. If the network node configures four resources, the first pair may correspond to SRI=0 and the second pair may correspond to SRI=1.

The network node may use SRI to indicate to the UE which panel should be used even when the ports of the panel span across multiple resources. Further, the network node may use TPMI to indicate a precoder and how it should be applied to the eight ports that are distributed across two SRS-Resources. The UE may use that information to configure transmissions on PUSCH.

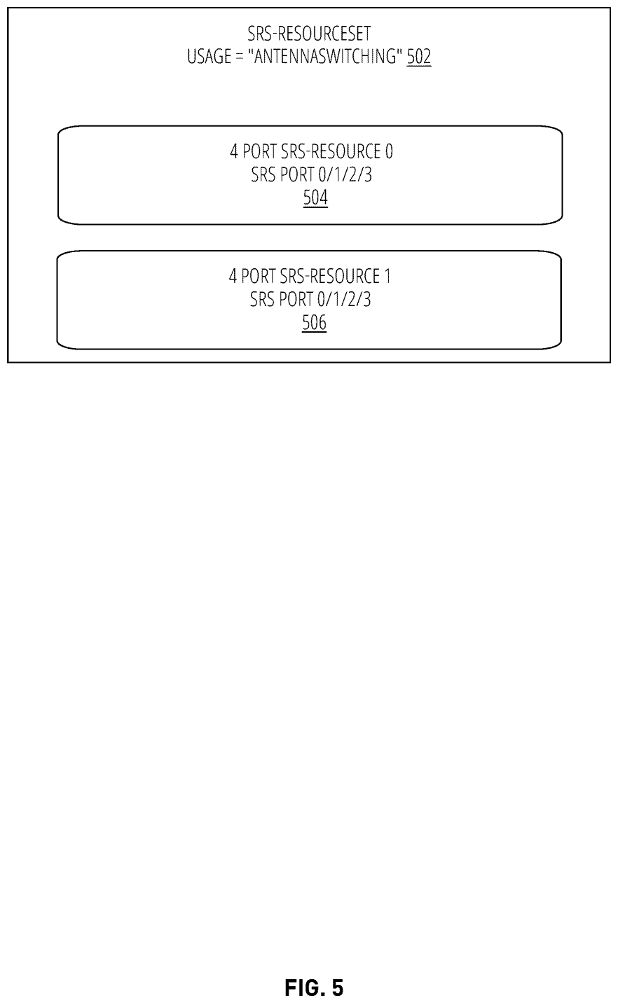

In some embodiments, mapping ports to multiple SRS resources may be applied to antenna switching. For example, FIG. 5 illustrates SRS-ResourceSet 502 with a usage set equal to “antennaSwitching.” For antenna switching, ports may be distributed across multiple SRS resources to support nTmR (i.e., using n Tx ports to sound m Rx ports). The UE may sound m Rx ports using multiple SRS-Resources (e.g., SRS-Resource 0 504, SRS-Resource 1 506) in the same SRS-ResourceSet (e.g., SRS-ResourceSet 502). Each SRS-Resource may have k ports, where k is less than the total number of Tx ports (n Tx ports).

For example, for 8T8R antenna switching SRS ResourceSet usage=“antennaSwitching” can be configured with two SRS-Resources (e.g., SRS-Resource 0 504, and SRS-Resource 1 506). As shown, SRS-Resource 0 504 may include four ports and SRS-Resource 1 506 may include four more ports. The UE may sound the Tx ports in both the SRS-Resource 0 504 and the SRS-Resource 1 506 to use the eight Tx ports to sound eight Rx ports.

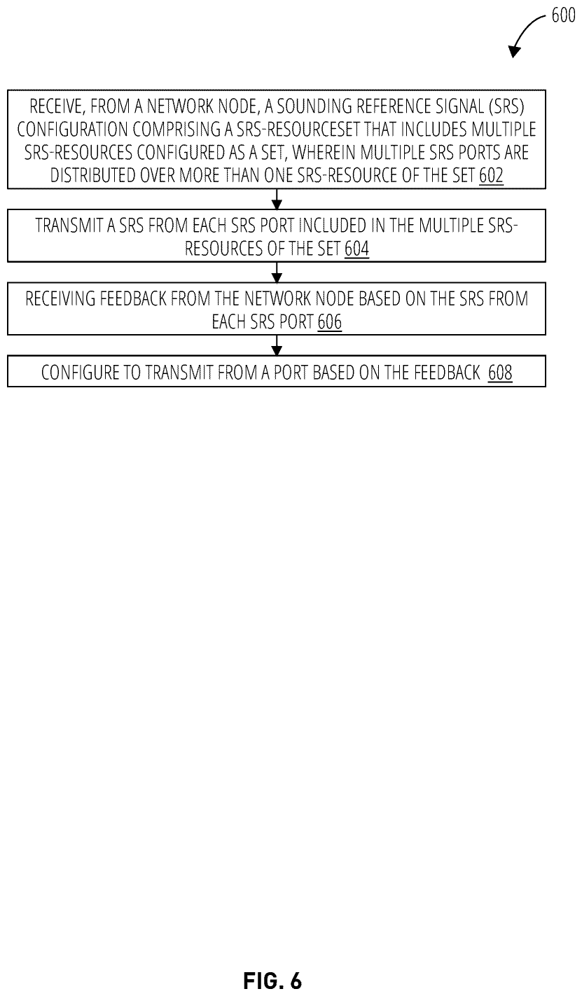

FIG. 6 illustrates a method 600 for a UE to perform SRS transmission from SRS ports across multiple SRS-Resources. The UE may receive 602, from a network node, a SRS configuration comprising a SRS-ResourceSet that includes multiple SRS-Resources configured as a set. Multiple SRS ports are distributed over more than one SRS-Resource of the set. In some embodiments, the set may comprise two SRS-Resources that are each mapped to four ports such that the set includes eight ports. In some embodiments, the SRS-ResourceSet may include a second set of SRS-Resources. The second set of SRS-Resources may include multiple SRS ports of a second panel distributed over more than one SRS-Resource of the second set.

The UE may transmit 604 a SRS from each SRS port included in the multiple SRS-Resources of the set. The UE may receive 606 feedback from the network node based on the SRS from each SRS port. In some embodiments, the feedback comprises a TPMI, wherein for mapping the TPMI to the SRS ports, the SRS ports of the multiple SRS-Resources in the set are concatenated based on an order of the multiple SRS-Resources in the SRS configuration. In some embodiments, the multiple SRS-Resources are grouped into two sets based on an order of the multiple SRS-Resources in the SRS configuration, wherein each set contains an equal or almost equal number of the multiple SRS-Resources. The feedback wherein may include an SRI field that indicates the set. For example, a first set of SRS-Resources may map to SRI=0, and a second set of SRS-Resources may map to SRI=1.

The UE may configure 608 to transmit on PUSCH from one or more ports based on the feedback. In some embodiments, the SRS configuration sets SRS-ResourceSet usage to antenna switching and the multiple SRS ports of the multiple SRS-Resources are transmit ports used for sounding an equal number of receive ports.

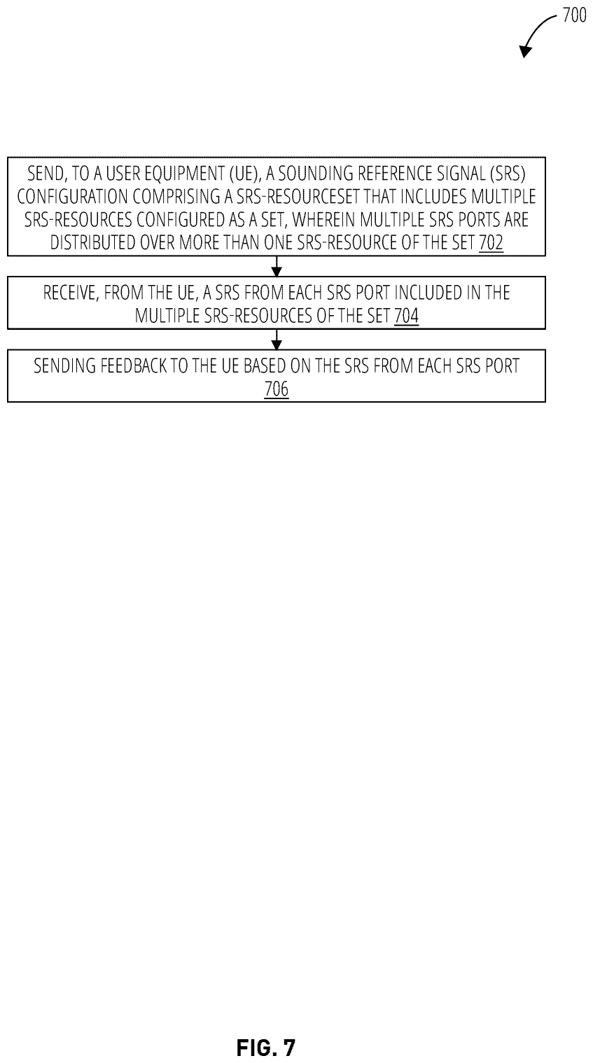

FIG. 7 illustrates a method 700 for a network node to configure SRS from SRS ports across multiple SRS-Resources. This method 700 may be used in combination with the method 600 shown in FIG. 6. The network node may send 702, to a UE, a SRS configuration comprising a SRS-ResourceSet that includes multiple SRS-Resources configured as a set. The multiple SRS ports may be distributed over more than one SRS-Resource of the set. The network node may receive 704, from the UE, a SRS from each SRS port included in the multiple SRS-Resources of the set. The network node may send 706 feedback to the UE based on the SRS from each SRS port. The network node may schedule the UE to transmit on PUSCH from one or more ports.

In some embodiments, to support multiple SRS ports in a single SRS-Resource, multiple symbols may be used. The multiple SRS ports may be split across multiple symbols. Thus rather than repeating a previous symbol, a second symbol may have different ports than a first symbol.

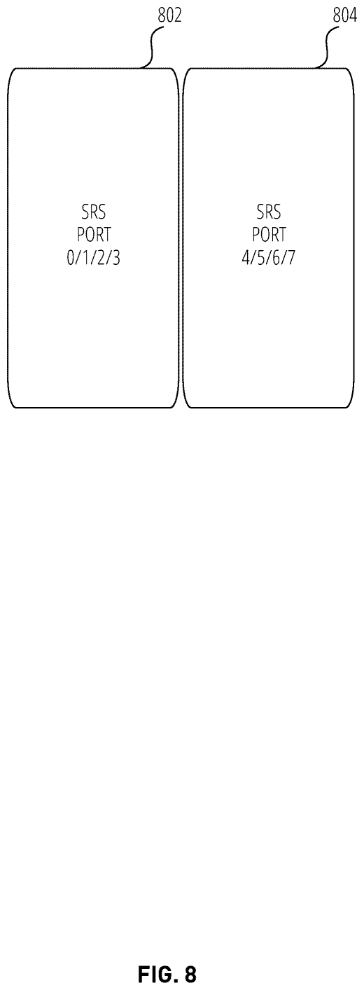

For example, FIG. 8 illustrates eight SRS ports divided into two groups of SRS ports (e.g., SRS ports 0, 1, 2, 3 and SRS ports 4, 5, 6, 7) to be transmitted on two different symbols. The first group of SRS ports comprises SRS ports 0, 1, 2, and 3. The second group of SRS ports comprises SRS ports 4, 5, 6, and 7. These two groups of ports may be split across multiple symbols such that the first group of SRS ports is transmitted on a first symbol 802 and the second group of SRS ports is transmitted on a second symbol 804. The eight SRS ports together may be from a single panel.

In some embodiments, a time domain orthogonal cover code (TD-OCC) can be used to map multiple SRS ports to multiple symbols. In some embodiments, a TD-OCC codebook can be created from an identity matrix. For example, for a length two TD-OCC, a two orthogonal cover code may be {1, 0} and {0, 1}. Multiple SRS ports can be created with two OFDM symbols. For example, to support eight port SRS, the UE may use a first symbol with cover code {1, 0} to transmit the first four ports (i.e., SRS port 0, 1, 2, 3), and the second symbol with cover code {0, 1} to transmit the next four ports (i.e., SRS port 4, 5, 6, 7).

In some embodiments, repetition may be used for the TD-OCC. For example, the two symbols covering the eight ports shown in FIG. 8 may be repeated using two, four, six, or any multiple of two additional symbols. The total length of the TD-OCC may be a multiple of the number of symbols used for the multiple ports.

There may be differences in comb offsets and/or cyclic shift between the two symbols transmitting when transmitting corresponding ports of the eight SRS ports. The corresponding SRS ports refers to the order of the SRS ports in each group of SRS ports. For example, in the illustrated embodiment, both SRS port 0 and SRS port 4 are the first SRS ports in their respective groups and are therefore said to correspond. Similarly, the other corresponding ports in FIG. 8 include {SRS port 1 and SRS port 5}, {SRS port 2 and SRS port 6} {SRS port 3 and SRS port 7}. In some embodiments, corresponding SRS ports in different symbols may have a different comb offset and/or a different cyclic shift.

In some embodiments, restrictions, in terms of comb offset and cyclic shift configuration, may be implemented for corresponding SRS ports in different symbols. In some embodiments, the restriction may be that corresponding SRS ports in different symbols have the same comb offset. In some embodiments, the restriction may be that corresponding SRS ports in different symbols have the same cyclic shift. In some embodiments, the restriction may be that corresponding SRS ports in different symbols have both the same comb offset and the same cyclic shift. For example, SRS port 0 and SRS port 4 may have the same comb offset and/or cyclic shift in different symbols. Similarly, the restriction may cause the other corresponding SRS ports (e.g., {SRS ports 1 and 5}, {SRS ports 2 and 6}, {SRS ports 3 and 7}) to have the same comb offset and/or cyclic shift in different symbols.

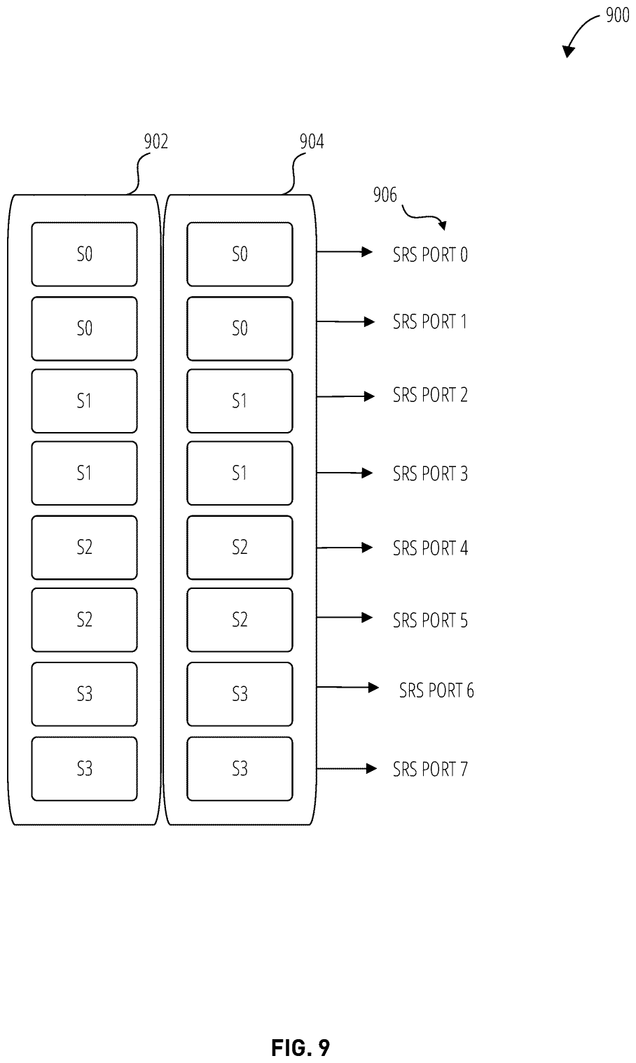

To support multiple SRS port in a single SRS-Resource, FIG. 9 illustrates how a TD-OCC codebook created from Hadamard matrix can be used to map multiple SRS ports to multiple symbols (e.g., first symbol 902 and second symbol 904). The Hadamard matrix may allow for increased capacity when mapping multiple SRS ports 906 to multiple symbols. The increased capacity allows for repetition such that each port may be mapped to both symbols.

For example, for length two TD-OCC, the two orthogonal cover code may be {1, 1} and {1, −1}. Multiple SRS ports can be configured with the orthogonal frequency division multiplexing (OFDM) symbols and the orthogonal cover code. For example, to support eight port SRS over two OFDM symbols (e.g., first symbol 902 and second symbol 904), four basic SRS ports (e.g., {S0, S1, S2, S3}) may be used. Each basic SRS port (e.g., {S0, S1, S2, S3}) may map to a unique comb offset and cyclic shift. Eight ports SRS can be configured by applying two orthogonal TD-OCC code over the two symbols on all the basic SRS ports.

For example, to support eight port SRS, the UE may use a first symbol with cover code {1, 1} to transmit the first four ports (i.e., SRS port 0, 1, 2, 3), and the second symbol with cover code {1, −1} to transmit the next four ports (i.e., SRS port 4, 5, 6, 7). The network node may determine the SRS values of individual SRS ports that are associated with common basic SRS ports (e.g., both SRS port 0 and SRS port 1 are associated with a common S0 port) by applying the cover code.

In some embodiments, to support multiple SRS port in a single SRS-Resource, a TD-OCC codebook can be created from a discrete Fourier transform (DFT) matrix (cyclic shifts). The DFT matrix TD-OCC codebook may be used to support ports spread across two or more symbols. For example, the DFT matrix TD-OCC codebook may be used to support 16 ports using four symbols. In some embodiments, for length N TD-OCC, the i^{th} entry in kth TD-OCC code may be: exp{j2π□i□k/N}, i, k=0, 1, . . . N−1. Creating multiple SRS ports over multiple symbols using the DFT matrix TD-OCC codebook may be similar to using TD-OCC codebook created from Hadamard matrix.

In some embodiments, intra-frequency hopping may be used when multiple SRS ports are created using N OFDM symbols, where N is the number OFDM symbols. The SRS resource configuration may comprise a value R that denotes the number of repeated symbols in SRS intra-frequency hopping. R may be set equal to a value in the repetitionFactor field if repetition factor is configured. Otherwise, R may be set equal to the number of symbols configured in the nrofSymbols field. For example, if a system uses intra-frequency hopping, and R is set to 2, the system may transmit 2 symbols then hop to a different frequency to transmit addition symbols. Both repetitionFactor and nrofSymbols may be configured in SRS-Resource by a network node via radio resource control (RRC). In some embodiments, there may be restrictions on the value of R. For example, in some embodiments, R has to be divisible by a length of TD-OCC (N). In other words, R has to be an integer multiple of N (i.e., length of TD-OCC).

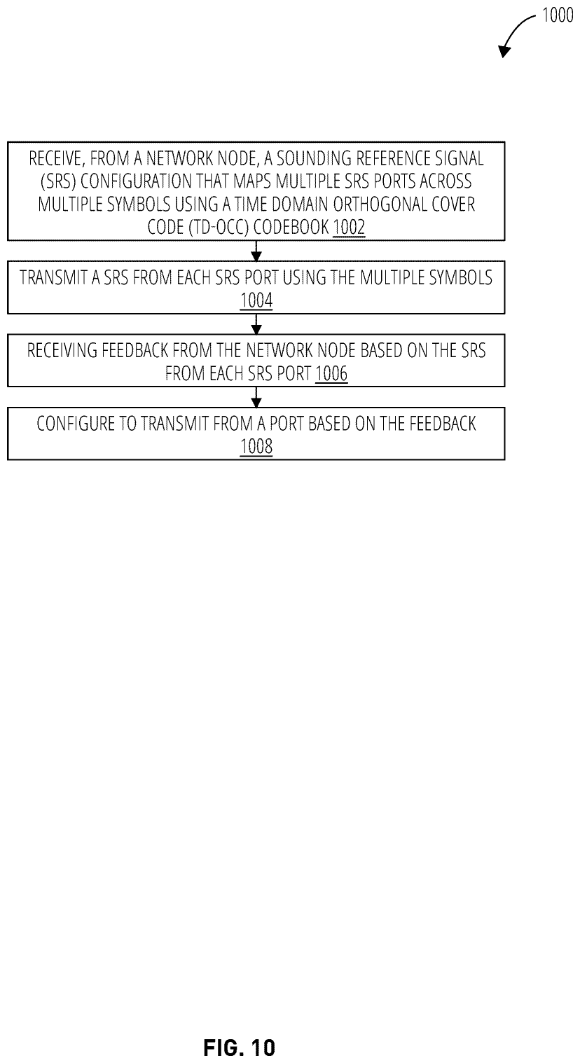

FIG. 10 illustrates a method 1000 for a UE to perform SRS from SRS ports across multiple symbols. The UE may receive 1002, from a network node, a SRS configuration that maps multiple SRS ports across multiple symbols using a TD-OCC codebook. The UE may transmit 1004, a SRS from each SRS port using the multiple symbols. The UE may receive 1006 feedback from the network node based on the SRS from each SRS port. The UE may configure 1008 to transmit on PUSCH from one or more ports based on the feedback.

In some embodiments, the TD-OCC codebook is created from an identity matrix. In some embodiments, corresponding SRS ports in different symbols have a same comb offset. In some embodiments, corresponding SRS ports in different symbols have a same cyclic shift. In some embodiments, the TD-OCC codebook is created from Hadamard matrix. In some embodiments, the TD-OCC codebook is created from DFT matrix. In some embodiments, the UE may perform frequency hopping while transmitting the SRS. In some embodiments, a number of repeated symbols in SRS intra-frequency hopping must be divisible by a length of a TD-OCC.

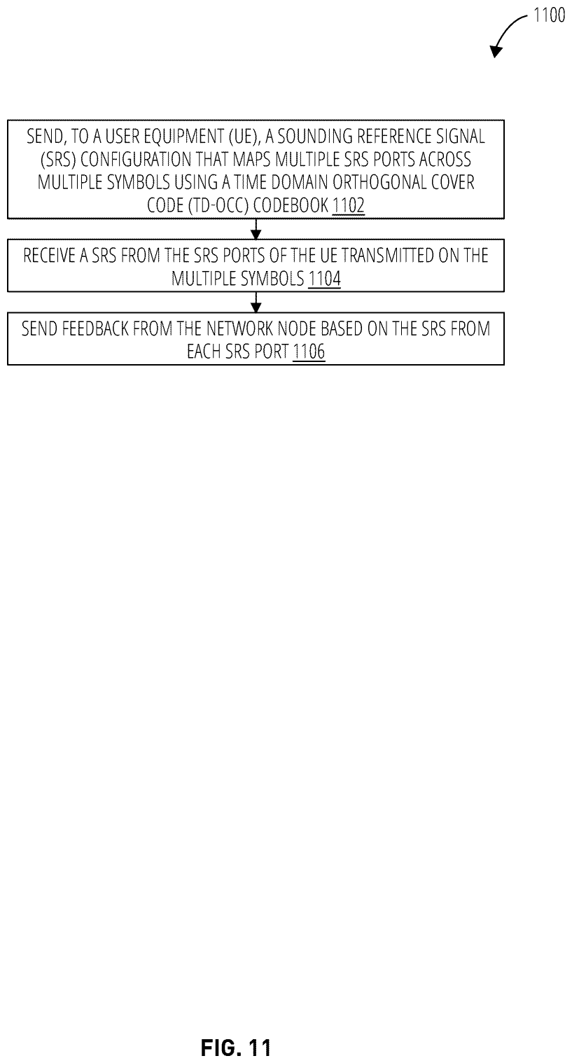

FIG. 11 illustrates a method 1100 for a network node to support SRS from SRS ports across multiple symbols. This method 1100 may be used in combination with the method 1000 shown in FIG. 10. The network node may send 1102, to a UE, a SRS configuration that maps multiple SRS ports across multiple symbols using a TD-OCC codebook. The network node may receive 1104, a SRS from the SRS ports of the UE transmitted on the multiple symbols. The network node may send 1106 feedback from the network node based on the SRS from each SRS port.

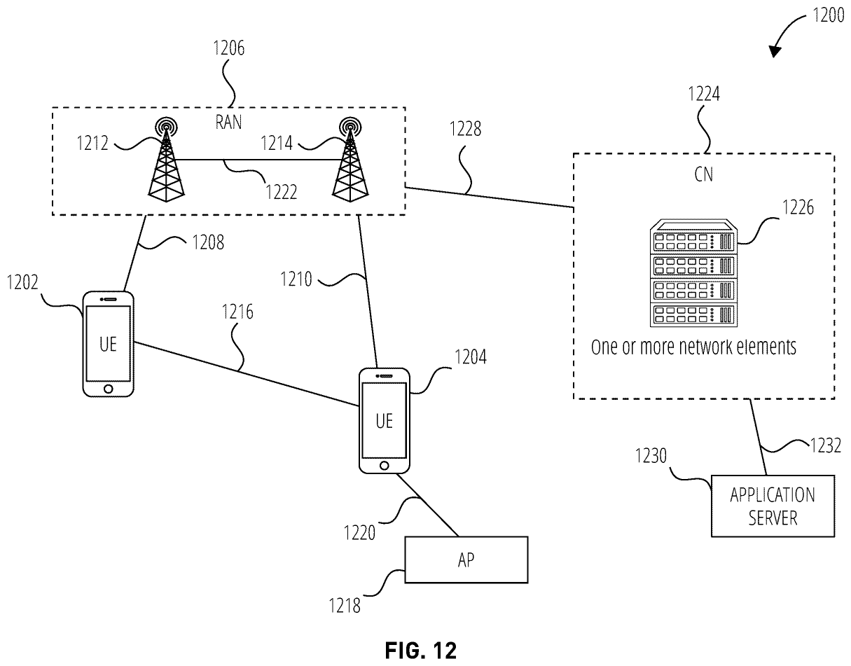

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations, such as base station 1212 and base station 1214, that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using OFDM communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

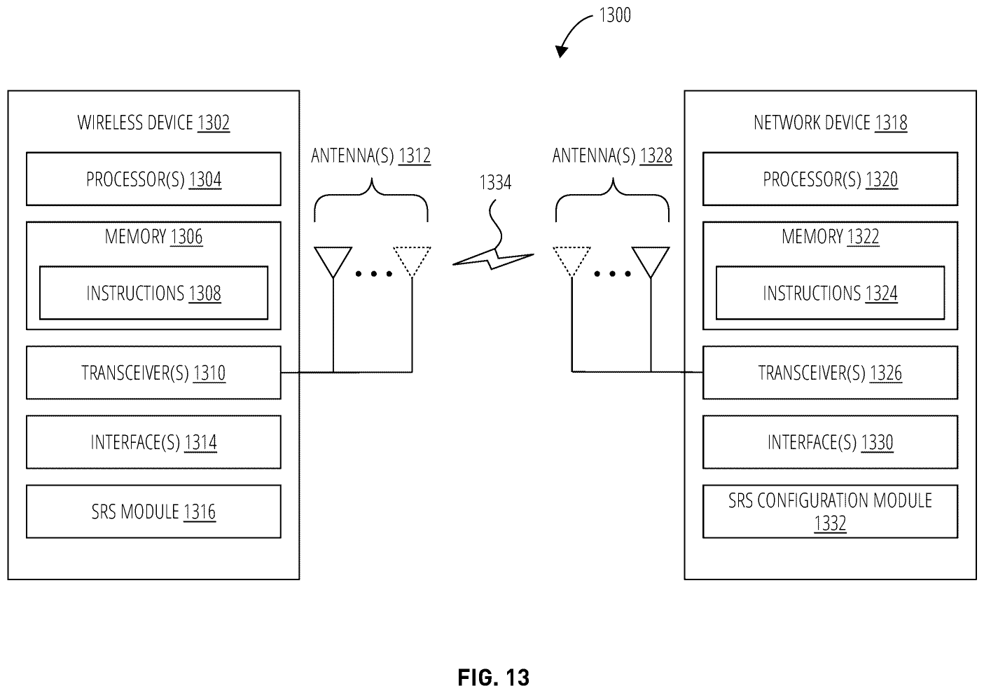

FIG. 13 illustrates a system 1300 for performing signaling 1334 between a wireless device 1302 and a network device 1318, according to embodiments disclosed herein. The system 1300 may be a portion of a wireless communications system as herein described.

The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include an SRS module 1316. The SRS module 1316 may be implemented via hardware, software, or combinations thereof. For example, the SRS module 1316 may be implemented as a processor, circuit, and/or instructions 1308 stored in the memory 1306 and executed by the processor(s) 1304. In some examples, the SRS module 1316 may be integrated within the processor(s) 1304 and/or the transceiver(s) 1310. For example, the SRS module 1316 may be implemented by a combination of software components (e.g., executed by a DSP or a general processor) and hardware components (e.g., logic gates and circuitry) within the processor(s) 1304 or the transceiver(s) 1310.

The SRS module 1316 may be used for various aspects of the present disclosure, for example, aspects of FIGS. 1-10. The SRS module 1316 is configured to send SRS based on configurations from the network device 1318.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include an SRS configuration module 1332. The SRS configuration module 1332 may be implemented via hardware, software, or combinations thereof. For example, the SRS configuration module 1332 may be implemented as a processor, circuit, and/or instructions 1324 stored in the memory 1322 and executed by the processor(s) 1320. In some examples, the SRS configuration module 1332 may be integrated within the processor(s) 1320 and/or the transceiver(s) 1326. For example, the SRS configuration module 1332 may be implemented by a combination of software components (e.g., executed by a DSP or a general processor) and hardware components (e.g., logic gates and circuitry) within the processor(s) 1320 or the transceiver(s) 1326.

The SRS configuration module 1332 may be used for various aspects of the present disclosure, for example, aspects of FIGS. 1-10. The SRS configuration module 1332 is configured to configure SRS transmissions from the wireless device 1302.

Embodiments contemplated herein include an apparatus comprising means to perform one or more elements of the method 600 or method 1000. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the method 600 or method 1000. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of the method 600 or method 1000. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of the method 600 or method 1000. This apparatus may be, for example, an apparatus of a UE (such as a wireless device 1302 that is a UE, as described herein).

Embodiments contemplated herein include a signal as described in or related to one or more elements of the method 600 or method 1000.

Embodiments contemplated herein include a computer program or computer program product comprising instructions, wherein execution of the program by a processor is to cause the processor to carry out one or more elements of the method 600 or method 1000. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

Embodiments contemplated herein include an apparatus comprising means to perform one or more elements of the method 700 or method 1100. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 700 or method 1100. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 700 or method 1100. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 700 or method 1100. This apparatus may be, for example, an apparatus of a base station (such as a network device 1318 that is a base station, as described herein).

Embodiments contemplated herein include a signal as described in or related to one or more elements of the method 700 or method 1100.

Embodiments contemplated herein include a computer program or computer program product comprising instructions, wherein execution of the program by a processing element is to cause the processing element to carry out one or more elements of the method 700 or method 1100. The processor may be a processor of a base station (such as a processor(s) 1320 of a network device 1318 that is a base station, as described herein). These instructions may be, for example, located in the processor and/or on a memory of the base station (such as a memory 1322 of a network device 1318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving, from a network node, a sounding reference signal (SRS) configuration comprising a SRS-ResourceSet that includes multiple SRS-Resources configured as a set, wherein multiple SRS ports are distributed over more than one SRS-Resource of the set;
transmitting a SRS from each SRS port included in the multiple SRS-Resources of the set;
receiving feedback from the network node based on the SRS from each SRS port; and
configuring to transmit from one or more ports based on the feedback.

2. The method of claim 1, wherein the set comprises two SRS-Resources that are each mapped to four ports such that the set includes eight ports.

3. The method of claim 1, wherein the SRS-ResourceSet includes a second set of SRS-Resources, wherein the second set of SRS-Resources includes multiple SRS ports of a second panel distributed over more than one SRS-Resource of the second set.

4. The method of claim 1, wherein the feedback comprises a Transmit Precoder Matrix Indicator (TPMI), wherein for mapping the TPMI to the SRS ports, the SRS ports of the multiple SRS-Resources in the set are concatenated based on an order of the multiple SRS-Resources in the SRS configuration.

5. The method of claim 1, wherein the multiple SRS-Resources are grouped into two sets based on an order of the multiple SRS-Resources in the SRS configuration, wherein each set contains an equal or almost equal number of the multiple SRS-Resources.

6. The method of claim 5, wherein the feedback includes an SRS resource indicator (SRI) field, wherein a first set of SRS-Resources maps to SRI=0, and a second set of SRS-Resources maps to SRI=1.

7. The method of claim 1, wherein the SRS configuration sets SRS-ResourceSet usage to antenna switching and the multiple SRS ports of the multiple SRS-Resources are transmit ports used for sounding an equal number of receive ports.

8. A user equipment (UE) comprising:
a processor; and
a memory storing instructions that, when executed by the processor, configure the UE to:
receive, from a network node, a sounding reference signal (SRS) configuration comprising a SRS-ResourceSet that includes multiple SRS-Resources configured as a set, wherein multiple SRS ports are distributed over more than one SRS-Resource of the set;
transmit a SRS from each SRS port included in the multiple SRS-Resources of the set;
receive feedback from the network node based on the SRS from each SRS port; and
configure to transmit from one or more ports based on the feedback.

9. The UE of claim 8, wherein the set comprises two SRS-Resources that are each mapped to four ports such that the set includes eight ports.

10. The UE of claim 8, wherein the SRS-ResourceSet includes a second set of SRS-Resources, wherein the second set of SRS-Resources includes multiple SRS ports of a second panel distributed over more than one SRS-Resource of the second set.

11. The UE of claim 8, wherein the feedback comprises a Transmit Precoder Matrix Indicator (TPMI), wherein for mapping the TPMI to the SRS ports, the SRS ports of the multiple SRS-Resources in the set are concatenated based on an order of the multiple SRS-Resources in the SRS configuration.

12. The UE of claim 8, wherein the multiple SRS-Resources are grouped into two sets based on an order of the multiple SRS-Resources in the SRS configuration, wherein each set contains an equal or almost equal number of the multiple SRS-Resources.

13. The UE of claim 12, wherein the feedback includes an SRS resource indicator (SRI) field, wherein a first set of SRS-Resources maps to SRI=0, and a second set of SRS-Resources maps to SRI=1.

14. A method for a network node, the method comprising:
sending, to a user equipment (UE), a sounding reference signal (SRS) configuration comprising a SRS-ResourceSet that includes multiple SRS-Resources configured as a set, wherein multiple SRS ports are distributed over more than one SRS-Resource of the set;
receiving, from the UE, a SRS from each SRS port included in the multiple SRS-Resources of the set; and
sending feedback to the UE based on the SRS from each SRS port.

15. The method of claim 14, wherein the set comprises two SRS-Resources that are each mapped to four ports such that the set includes eight ports.

16. The method of claim 14, wherein the SRS-ResourceSet includes a second set of SRS-Resources, wherein the second set of SRS-Resources includes multiple SRS ports of a second panel distributed over more than one SRS-Resource of the second set.

17. The method of claim 14, wherein the feedback comprises a Transmit Precoder Matrix Indicator (TPMI), wherein for mapping the TPMI to the SRS ports, the SRS ports of the multiple SRS-Resources in the set are concatenated based on an order of the multiple SRS-Resources in the SRS configuration.

18. The method of claim 14, wherein the multiple SRS-Resources are grouped into two sets based on an order of the multiple SRS-Resources in the SRS configuration, wherein each set contains an equal or almost equal number of the multiple SRS-Resources.

19. The method of claim 18, wherein the feedback includes an SRS resource indicator (SRI) field, wherein a first set of SRS-Resources maps to SRI=0, and a second set of SRS-Resources maps to SRI=1.

20. The method of claim 18, wherein the SRS configuration sets SRS-ResourceSet usage to antenna switching and the multiple SRS ports of the multiple SRS-Resources are transmit ports used for sounding an equal number of receive ports.
